(19) United States
(12) Patent Application Publication
(10) Pub. No.: US 2008/0078099 A1
(43) Pub. Date: Apr. 3, 2008

(54) Steam heat treatment apparatus particularly for condensation soldering

(76) Inventors: Adam Schulz, Augsburg (DE); Thomas Kunz, Augsburg (DE)

Correspondence Address: KLAUS J. BACH, 4407 TWIN OAKS DRIVE, MURRYSVILLE, PA, 15668, US

(21) Appl. No.: 11/700,552

(22) Filed: Jan. 31, 2007

(30) Foreign Application Priority Data
May 6, 2006 (DE) 10 2006 021 181.2

(51) Int. Cl. F26B 3/02

(52) U.S. Cl. 34/470

(57) ABSTRACT

In a steam heat treatment apparatus including a chamber having an access opening for the introduction and removal of a workpiece and a steam generator associated with the chamber for generating a steam atmosphere in the chamber, a steam cooling device is provided in communication with the chamber for circulating steam through the chamber and control means are provided for controlling the steam atmosphere in the chamber by controlling steam circulation through the chamber, steam generation in the chamber and steam condensation in the steam cooling or condensing device.

### BACKGROUND OF THE INVENTION

The invention relates to a steam heat treatment apparatus particularly for the condensation soldering of electronic components.

The condensation soldering of electronic components is a well-known process for the attachment of electronic components to conductor plates or electric circuit boards.

For this purpose, electronic components are mechanically fixed on the conductor plates that their connectors are mechanically in contact with the conductor plate with which they are to be connected and to which a soldering paste has already been applied. The soldering process is performed in a soldering chamber using hot steam whose temperature is above the melting temperature of the soldering material and which condenses on the metallic conductors to which the solder has been applied beforehand. The solder material is in the process melted by the hot steam and the electronic components are soldered to the conductor plates or circuit boards.

The principal technical problem encountered during soldering in particular integrated electronic circuit boards with a large number of connectors to electric conductor plates resides in the attempt to limit the heat exposure of the heat sensitive electronic components but still supply to the soldering locations the heat necessary for the melting of the solder and the rapid and reliable establishment of a secure solder connection. To avoid damage to the electronic components, care must be taken that the residence time of the components in the hot steam atmosphere is properly limited which can be achieved by ensuring that the heat is supplied to the soldering locations efficiently and rapidly.

EP 0 931 618 discloses a condensation soldering apparatus by which a heat transfer liquid is applied to the earlier heated bottom of a condensation soldering chamber and is vaporized therein so as to fill the condensation soldering chamber with steam.

Furthermore, from EP-0 966 337, a condensation soldering apparatus is known which is provided with two types of steam generating devices, that is, a device with a liquid bath including a heater disposed at the bottom of a condensation soldering chamber and another device with a heated plates disposed at the bottom of the condensation chamber onto which a liquid is sprayed via spray nozzles for the vaporization of the liquid. The heat input into the condensation chamber is to be controlled via the steam amount or the steam temperature which is achieved by controlled heating of the liquid bath or the controlled energizing of the heating plate.

However, in these known condensation soldering apparatus, it is a disadvantage that the control of the steam conditions in the condensation soldering chambers is difficult, slow and inaccurate and the heat distribution in the condensation soldering chambers is furthermore hardly uniform. Generally, there are at least vertical temperature gradients in the chambers. As a result, the respective conditions in the soldering chamber are not accurately known. Rather, the steam chamber temperature is determined based on the liquid bath temperature or the heating plate temperature wherein it is assumed that there is a uniform heat distribution throughout the soldering chamber.

Finally, DE 198 26 520 discloses a condensation soldering apparatus including a condensation soldering chamber wherein a steam-free space is provided above the steam volume and the heat transfer to the workpiece is controlled by a corresponding immersion of the workpiece from the steam-free space into the steam volume. The workpiece is first deeply immersed into the steam volume for rapid initial heating and is then raised into the interface area of the steam phase for a slower final heating of the workpiece. This process however operates with a desired temperature gradient in the condensation soldering chamber so that the accuracy of the heat control appears to be very questionable.

It is the object of the present invention to provide a steam heat treatment apparatus wherein the heat transfer conditions can be controlled rapidly and accurately so that the conditions in the treatment chamber are known and accurately controllable.

### SUMMARY OF THE INVENTION

In a steam heat treatment apparatus including a chamber having an access opening for the introduction and removal of a workpiece and a steam generator associated with the chamber for generating a steam atmosphere in the chamber, a steam cooling device is provided in communication with the chamber for circulating steam through the chamber and control means are provided for controlling the steam atmosphere in the chamber by controlling steam circulation through the chamber, steam generation in the chamber and steam condensation in the steam cooling or condensing device.

The apparatus according to the invention controls the steam temperature directly and consequently directly controls the temperature gradient between the steam and the workpiece whereby any desired temperature gradient and a uniform temperature distribution in the steam chamber can be established and the heat transfer is improved by droplet or film condensation of the steam on the workpiece.

The steam heat treatment apparatus according to the invention is described with reference to a condensation soldering apparatus, but such a steam heat treatment apparatus may also be used for other applications, for example in disinfection or cleaning apparatus.

Below, the steam heat treatment apparatus will be described in connection with various embodiments thereof with reference to the accompanying Drawings.

### BRIEF DESCRIPTION OF THE DRAWINGS

FIG. 1 shows schematically a first embodiment of a steam condensation soldering apparatus according to the invention,

FIG. 2 shows schematically a second embodiment of a steam condensation soldering apparatus, and

FIG. 3A and FIG. 3B shows a third embodiment of a steam condensation soldering apparatus in different adjustment situations.

### DESCRIPTION OF PARTICULAR EMBODIMENTS

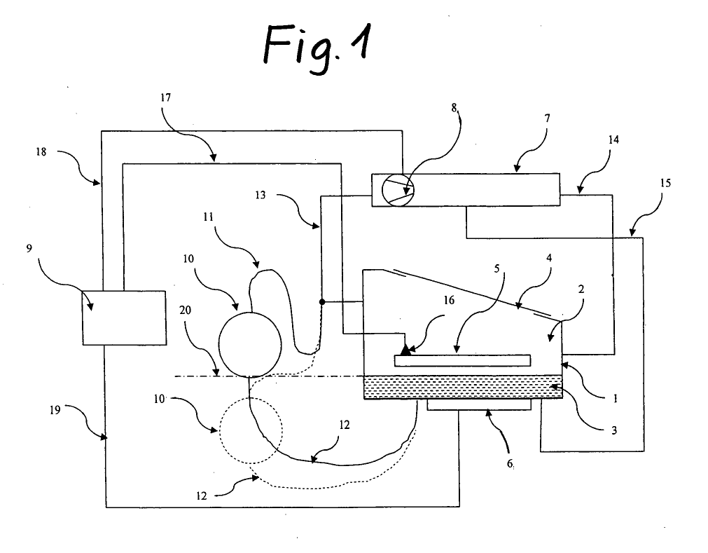

The steam heat treatment apparatus shown in FIG. 1 represents a completely gas and steam-tight system. It comprises a condensation chamber 1 with an interior space 2. In the bottom area of the condensation chamber 1 a liquid bath 3 is disposed which can be heated by a heater 6 in order to evaporate liquid and generate in the interior space 2 a steam atmosphere. The liquid bath 3 with the heater 6 forms a steam generator.

The condensation chamber 1 represents a soldering chamber which has at least one access opening which, in the embodiment shown, is covered by a pivot lid 4, preferably in the form of a sight window. The pivot lid 4 together with the chamber top wall is inclined relative to a horizontal plane in order to provide for a simple condensate drainage. The access opening closed by the pivot lid 4 facilitates the introduction and the removal of a workpiece 5 into, or respectively out of, the interior space 2.

The chamber 2 is connected to a cooling device in the form of a condenser 7, which is in communication with the chamber space 2 via a steam suction line 13 and a steam return line 14. The condenser 7 is for example air cooled but other cooling systems such as water cooling or Peltier elements may be employed. A condensate return line 15 extends from the condenser 7 to the liquid bath 3. A control unit 9 controls the operation of the condensation soldering apparatus and the steam conditions in the chamber space 2. A temperature sensor 16 is arranged in the chamber space 2, preferably on the workpiece 5 or a workpiece carrier and is connected to the control unit 9 by a signal transmission line 17. The control unit controls the operating procedures and conditions in the chamber space 2 depending on control values entered manually or by a computer program. Depending on the given control values, the control unit provides for the desired temperature gradients between the steam atmosphere and the workpiece in the chamber space 2.

For soldering, the workpiece 5 is placed into the chamber space 2 through the opening covered by the lid 4. This can be done manually or in an automated manner. Then the lid 4 is closed gas- and steam-tight. Under control of the control unit 9, the heater 6 is then energized and the liquid bath 3 is heated in a controlled manner up to its boiling temperature. As a result, steam is generated part of which condenses on the workpiece 5 and releases condensation heat thereto. The heater 6 is controlled so as to provide for a temperature in the liquid bath 3 and, consequently, a steam amount and temperature which depend on selectable settings. The soldering chamber 1 with the temperature sensor 16 arranged in the chamber space 2 and the liquid bath 3 heated by the heater 6 and the condenser 7 with the circulation blower 8 form with the control unit 9 a closed control circuit for controlling the steam conditions in the chamber space 2 in accordance with the given control settings or control curves. If the control unit 9 determines, via the temperature sensor 16 and the signal transmission line 17, that the steam temperature and, consequently, the process temperature in the chamber space 2 is too low, the control unit 9 causes the heater 6 via the control line 19 to increase its heat output. If the steam temperature sensed exceeds the desired operating value in the chamber space 2, the control unit 9 first shuts the heater 6 down via the control line 19. Then it activates the blower 8 via the blower control line 18, whereby, via the steam suction line 13, steam is sucked out of the chamber space 2 and drawn through the condenser 7. In the condenser 7, the steam is at least partially condensed whereby the steam is cooled. Via the steam return line 14, the cooled steam from the condenser is returned to the chamber space 2, whereby the steam atmosphere contained therein is also cooled. If the temperature then drops below the desired value, the control unit 9 shuts the blower 8 off and the heater 6 on again.

The steam atmosphere circulation occurring with the steam temperature control in the chamber space 2 by means of the condenser and circulation blower 8 results in turbulence in the chamber space 2 and consequently provides for uniform heat distribution in the steam atmosphere in the chamber space 2. At the same time, the turbulence in the steam atmosphere also causes the formation of condensation seeds which condense partially as droplets on the workpiece 5. This droplet condensation provides for an effective heat transfer to the workpiece which, as a result, is rapidly heated.

With the apparatus according to the invention, the workpiece 5 cannot only be heated in the soldering chamber 1, but it can also be cooled down in a controlled manner. Herefor, the steam atmosphere can be cooled down by the control unit 9 in accordance with a predetermined temperature profile using the circulation blower 8 and the condenser 7 and also the heater 6 if the cooling occurs momentarily too rapidly so that the temperature of the steam atmosphere drops momentarily below the desired value.

When the workpiece has been cooled down to the desired temperature, the lid 4 can be opened so that the workpiece can be removed from the chamber space 2. Before the removal of the workpiece, the circulating blower 8 may remain switched on for a short period in order to remove and condense as much steam out of the chamber space 2 as possible via the condenser 7.

The condenser 7 is also used during the treatment of the workpiece in the chamber space 2 for the condensation of excess steam for preventing an excessive pressure increase in the chamber space 2, that is, for controlling the pressure in the chamber space 2. This is achieved as follows: If the pressure in the chamber space 2 increases because of the increasing temperature and the increased steam generation resulting therefrom, part of the steam flows via the line 13 to the condenser 7 where it is again condensed. The condensate flows via the condensate return line 15 back to the liquid bath 3. As a result, excess pressure is reduced and the pressure in the chamber space 2 is maintained essentially at atmosphere level.

In order to minimize liquid losses from the liquid bath 3 and also losses of steam generated from the liquid bath, the liquid can be removed from the liquid bath temporarily after completion of the soldering procedure and before the removal of the workpiece from the chamber space 2 so that the steam formation is totally interrupted when the lid 3 is opened. For this purpose, a liquid container 10 may be provided outside the soldering chamber 1, which is movable between a raised position (shown in solid line) and a lowered position (shown by dashed lines) and which is in communication via a flexible line 12 with the liquid bath 3 and via a pressure compensation line 11 also with the steam suction line 13 or directly with the chamber space 2. In the raised position, the container 10 is disposed above, or mostly above, the liquid level 20 of the liquid bath 3 so that the liquid flows into the liquid bath 3, which is filled thereby. In the lowered position, the container 10 is disposed below the bottom level of the liquid bath 3 so that the content of the liquid bath 3 drains into the storage container 3. Of course, a liquid level control in the liquid bath 3 can also be achieved by such an arrangement depending on the design volume of the liquid storage container 10 and a control of the container height position. The liquid storage container may also include its own heating device (not shown) for heating the liquid volume in the storage container or maintaining it at a selectable temperature.

In the embodiment shown herein, the liquid storage container 10 is arranged so as to be vertically moveable in order to permit the filling or emptying and a liquid level adjustment of the liquid bath 3. Obviously, the liquid storage container may be stationary and a pump 12′ may be provided for filling and emptying the liquid bath.

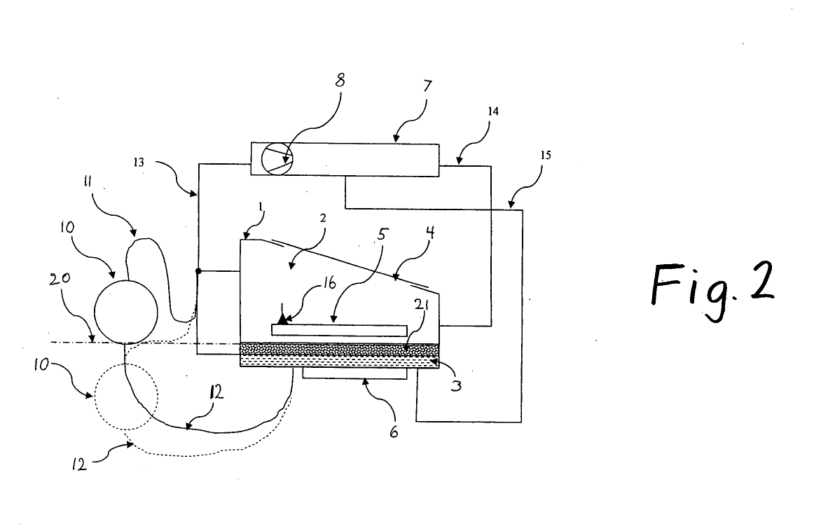

FIG. 2 shows a modified embodiment of the condensation soldering apparatus according to the invention. In FIG. 2, elements identical to those of FIG. 1 are designated by the same reference numerals. For simplicity reasons, the control unit with the respective control lines and measuring lines are not shown.

The embodiment according to FIG. 2 differs from that according to FIG. 1 only by a modification of the liquid bath 3 which, in the embodiment of FIG. 2 is covered by a steam brake 21. The steam brake 21 may be formed by a porous, liquid storage structure. This may be for example a fine mesh lattice structure on which a uniform sand layer is disposed or a porous ceramic body or another structure with the capability of accommodating and storing a liquid and releasing it again. The effect of the steam brake depends on the respective liquid level within the steam brake 21. The steam brake effect is highest if the liquid level is below the steam brake. The steam brake effect becomes smaller with increasing liquid level within the steam brake. This can be controlled by a movable liquid storage container 10 or an arrangement with a similar effect.

Controlling the liquid level within the steam brake permits controlling the steam generation.

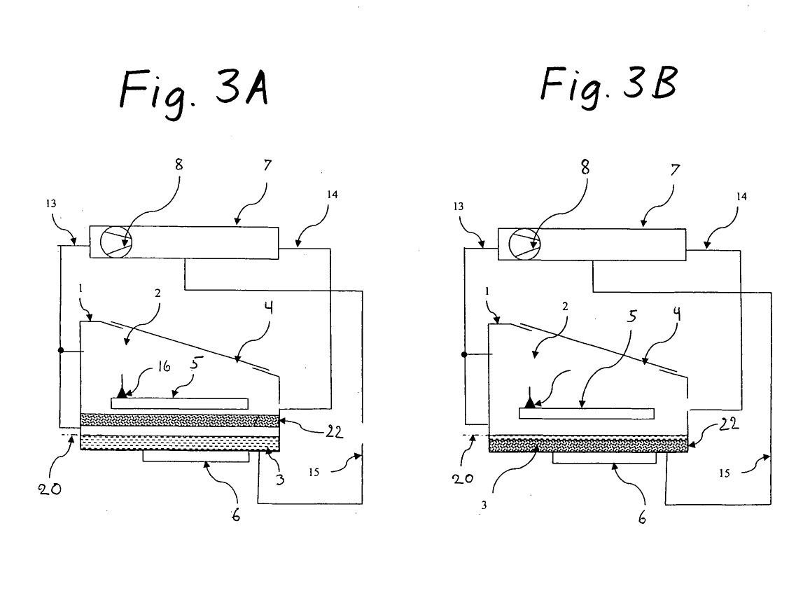

FIGS. 3A and 3B show a further modified embodiment wherein the liquid bath 3 is again covered by a steam brake. While in the embodiment of FIG. 2, the steam brake 21 is stationary, in the embodiment of FIGS. 3A, 3B, a height adjustable steam brake 22 is provided. By adjustment of the height position of the steam brake 22 consequently the liquid level within the steam brake can be adjusted. The arrangement according to FIGS. 3A, 3B, therefore does not require an arrangement for controlling the liquid level in the liquid bath 3 as it is provided for the arrangement of FIG. 2 by the height adjustable storage container 10. FIG. 3A shows the steam brake raised over the liquid level of the liquid bath 3 whereby the steam release to the chamber space 2 is minimized. FIG. 3A shows the steam brake lowered below the liquid level of the liquid bath 3, that is, immersed fully into the liquid bath 3 in which position the steam release to the chamber space 2 is maximized.

Other than shown in the embodiments of FIGS. 2 and 3A and 3B, instead of a steam brake, a steam barrier may be provided which is adjustable between an open end a closed position, for example, in the form of two plates with openings, which plates are slidable relative to each other for partially or fully opening or closing the openings.

What is claimed is:

1. A steam heat treatment apparatus (1) including a chamber (2) having an access opening (4) for the introduction and removal of a workpiece (5),
a steam generating device (3, 6) associated with the chamber (2) for generating a steam atmosphere in the chamber (2),
a steam cooling structure (7) arranged outside the chamber (2) and being in communication with the chamber (2) via a steam supply line (14) and a steam return line (13), means (8) for circulating the steam from the chamber (2) via the supply line (14) to the steam cooling structure (7) and via the return line (13) back to the chamber (2), and a control unit (9) for controlling the steam atmosphere condition in the chamber (2) by controlling operation of the steam generating device (3, 6) and the circulation means (8) depending on a selectable value input and a momentary condition in the chamber (2) as determined at least by a temperature sensor disposed in the chamber 2.

2. The apparatus as claimed in claim 1, wherein the steam generating device is formed by a liquid bath (3) arranged at the bottom of the chamber (2) and a heating device (6) disposed in heat transfer relation with the liquid bath (3).

3. The apparatus as claimed in claim 1, wherein the cooling device (7) is a steam condenser.

4. The apparatus as claimed in claim 3, wherein the return line (13) is a condensate return line extending from the steam condenser to the liquid bath (3).

5. The apparatus as claimed in claim 1, wherein an arrangement (10, 12) for selectively filling and emptying the liquid bath (3) and also for adjusting the liquid level in the bath (3) is connected to the liquid bath (3).

6. The apparatus as claimed in claim 5, wherein the arrangement (10, 12) for selectively filling and emptying the liquid bath (3) and adjusting the liquid level thereof is a liquid storage container (10), which is vertically movably supported and is in communication with the liquid bath (3) via a flexible line (12).

7. The apparatus as claimed in claim 5, wherein the arrangement (10, 12) for selectively filling and emptying the liquid bath (3) comprises a liquid storage container and pumping means (12′) for pumping liquid out of the bath into the storage container (10) and back from the storage container (10) into the liquid bath (3).

8. The apparatus as claimed in claim 1, wherein an arrangement (10, 12) for selectively filling and emptying the liquid bath (3) is provided which comprises a storage container (10) including heating means for heating the liquid in the storage container (10).

9. The apparatus as claimed in claim 2, wherein the liquid bath (3) includes a steam brake (21) in the form of a porous layer disposed in the liquid bath (3) and having a certain vertical thickness and the liquid level (20) and the steam brake (21) are height adjustable relative to each other such that the liquid level in the steam brake is selectable.

10. The apparatus as claimed in claim 9, wherein the steam brake is heatable.

11. The apparatus as claimed in claim 9, wherein the steam brake (22) is height adjustable for adjusting the liquid level within the steam brake (22).

12. The apparatus as claimed in claim 1, wherein a steam barrier is arranged between the steam generator and the chamber 2, said steam barrier being adjustable between an open and a closed position.
